(19) United States
(12) Patent Application Publication
(10) Pub. No.: US 2017/0230198 A1
(43) Pub. Date: Aug. 10, 2017

(54) Tunnel Between Interior Border Gateway Protocol Neighbors

(71) Applicant: HANGZHOU H3C TECHNOLOGIES CO., LTD., Zhejiang (CN)

(72) Inventor: Wei XU, Beijing (CN)

(21) Appl. No.: 15/502,122

(22) PCT Filed: Aug. 5, 2015
(86) PCT No.: PCT/CN2015/086117

§ 371 Date: Feb. 6, 2017

(30) Foreign Application Priority Data
Aug. 5, 2014 (CN) 201410381280.5

(51) Int. Cl. H04L 12/46; H04L 12/851; H04L 12/715; H04L 12/725; H04L 29/12; H04L 12/751

(52) U.S. Cl. CPC H04L 12/4633; H04L 29/12; H04L 45/02; H04L 45/04; H04L 45/30; H04L 47/2441

(57) ABSTRACT

A tunnel between interior border gateway protocol neighbor includes: receiving an announcement from an Interior Border Gateway Protocol (IBGP) neighbor, wherein the announcement from the IBGP neighbor includes an address used by the IBGP neighbor in creating the neighborhood with the border device; setting up a tunnel with an address used by the border device in creating the neighborhood with the IBGP neighbor being a local address, and the address used by the IBGP neighbor in creating the neighborhood with the border device being a remote address; and determining the IBGP neighbor as the next hop of a BGP route issued by the IBGP neighbor and a local interface of the tunnel as the outgoing interface of the BGP route.

### BACKGROUND

The Internet may be segmented into a number of different Autonomous Systems (ASs) for the purpose of management and extension. In other words, the Internet comprises a collection of ASs, which are a set of routing devices provided with the same route selection policy and belonging to the same technical administration department.

Route selection protocols may be categorized into Interior Gateway Protocols (IGPs) and Exterior Gateway Protocols (EGPs). The IGP, which is a route protocol applicable within an AS, is configured to select a route for a data message within the AS. The IGP will be applicable only within the AS but agnostic to the other ASs. The EGP, which is a route protocol applicable among a number of ASs, is configured to select a route of a data message among the ASs, or in other words, the data message may arrive at a destination address only if those ASs passed by the data message are determined. The EGP applicable among the respective ASs has knowledge of a general topology of the ASs but no knowledge of topologies within the respective ASs.

### BRIEF DESCRIPTION OF THE DRAWINGS

FIG. 1 illustrates a network deployment structural diagram of a number of ASs in an example;

FIG. 2 illustrates a schematic hardware architectural diagram of a border device in an AS in an example;

FIG. 3 illustrates a flow chart of a routing method on a border device for traversing an AS in an example;

FIG. 4 illustrates a flow chart of a border device transmitting a BGP Open message in an example;

FIG. 5 illustrates a flow chart of a border device processing a BGP Open message received from a peer border device in an example;

FIG. 6 illustrates a flow chart of a border device transmitting a BGP Route-Refresh message in an example;

FIG. 7 illustrates a flow chart of a border device processing a BGP Route-Refresh message received from a peer border device in an example;

FIG. 8 illustrates a flow chart of a border device setting up a tunnel and checking connectivity in an example;

FIG. 9 illustrates a flow chart of a border device tearing down a tunnel in an example;

FIG. 10 illustrates a flow chart of a border device relaying a route from a peer border device in an example; and

FIG. 11 illustrates a schematic diagram of functional modules in a routing control logic device for traversing an autonomous system in an example.

### DETAILED DESCRIPTION OF THE EMBODIMENTS

The Border Gateway Protocol (BGP) is a dynamic EGP applicable both among different ASs and within the same AS. The BGP operating within the same AS may be referred to an Internal BGP (IBGP); and the BGP operating among different AS may be referred to as an External BGP (EBGP). The BGP protocol has been applied in networks of operators due to its stability and capability to process a number of routes, and also a route is transferred in some large enterprise networks using the BGP.

As per the BGP protocol, a route is transferred by an IBGP neighbor in an AS domain. The BGP may be configured complexly, in an example, the BGP is configured on border devices of the AS, which are connected with another AS, and a BGP route is announced among several border devices in the AS by setting up an IBGP neighbor which is not directly connected. A data message is forwarded within the AS using the IGP, e.g., the Enhanced Interior Gateway Routing Protocol (EIGRP), the Open Shortest Path First (OSPF), the Intermediate System to Intermediate System Intra-Domain Routing Exchange Protocol (ISIS) and other protocols.

Taking as an example a network deployment structure including a plurality of ASs illustrated in FIG. 1, a border device 111 of an AS 110 and a border device 121 of an AS 120, and a border device 122 of the AS 120 and a border device 131 of an AS 130 are EBGP neighbors; and the border device 121 and the border device 122 are IBGP neighbors. Within the AS 120, the BGP may not operate on routing device 123 and routing device 124, but the IGP operates on the four devices within the AS 120, and there are two redundant forward paths between the border device 121 and the border device 122.

The IGP operates on all of routing devices in an AS, and the BGP operates on border devices connected with another AS. Taking the AS 120 illustrated in FIG. 1 as an example, the IGP operates on the border device 121, the border device 122, the routing device 123, and the routing device 124 of the AS 120, and the BGP operates on the border device 121 and the border device 122 of the AS 120. Thus a data message going to traverse the AS 120 may be routed among the AS 110, the AS 120 and the AS 130 using the BGP, and routed within the AS 120 using the IGP. In this case, when the data message is passing within the AS 120, since a destination address of the data message may be the address of the AS 110 or the AS 130, the data message may be discarded by the routing device 123 and the routing device 124 on which the IGP operates, due to the unreachable destination address of the data message, thus forming a route black-hole.

In an example, a routing control logic operating on an AS border device may avoid a route black-hole, without degrading the performance of the IGP and without increasing a workload on a network administrator. In this example, a border device on which the BGP operates in an AS and at least one other border device on which the BGP operates in the same AS are IBGP neighbors of each other, and the routing control logic may operate on each of the border devices. For instance, in the AS 120 of FIG. 1, routing devices 121 and 122 are border device and may be IBGP neighbors of each other. As shown in FIG. 1, each of these IBGP neighbors may include a routing control logic 1100.

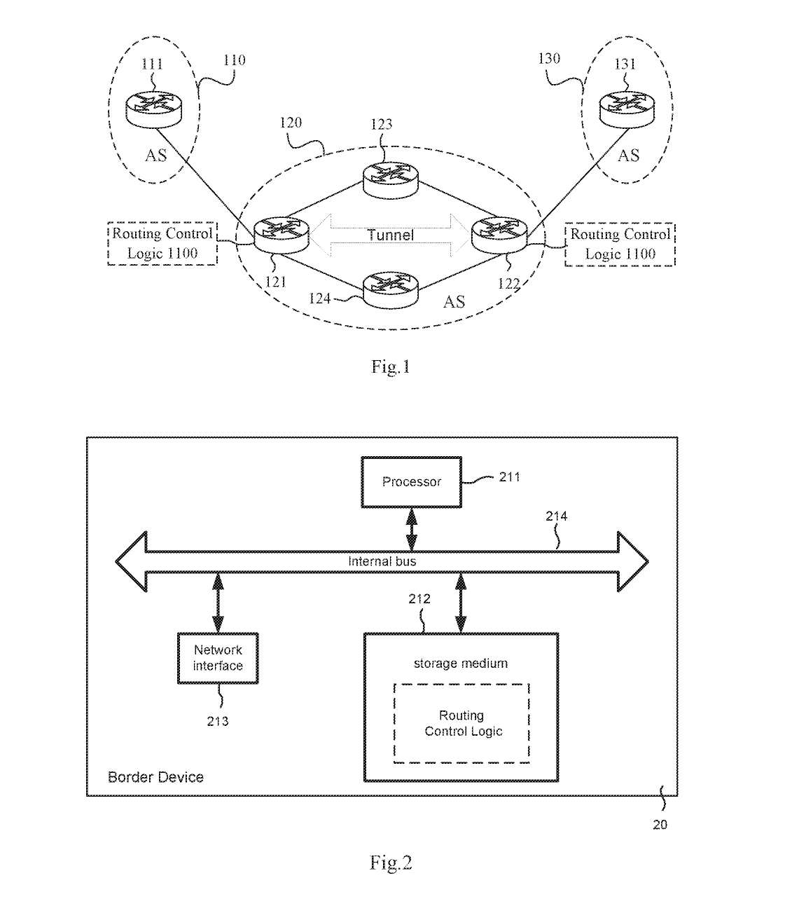

Referring to FIG. 2, a border device 20 may include a processor 211, a non-transitory machine readable storage medium 212 and a network interface 213, all of which are connected with each other by an internal bus 214. In this example, machine readable instructions corresponding to a routing control logic are stored in the storage medium 212. The processor 211 reads the machine readable instructions corresponding to the routing control logic, stored in the storage medium 212 to perform the routing control logic.

The non-transitory machine readable storage medium 212 may be any electronic, magnetic, optical or another physical storage device which may contain or store information, e.g., executable instructions, data, etc. For example the machine readable storage medium 212 maybe a Random Access Memory (RAM), a volatile memory, a nonvolatile memory, a flash memory, a storage driver (e.g., a hard disk driver), a solid-state hard disk, any type of storage disks (e.g., a CD, a DVD, etc.) or the like, or any combination thereof. Moreover any machine readable storage medium described in this application may be nonvolatile.

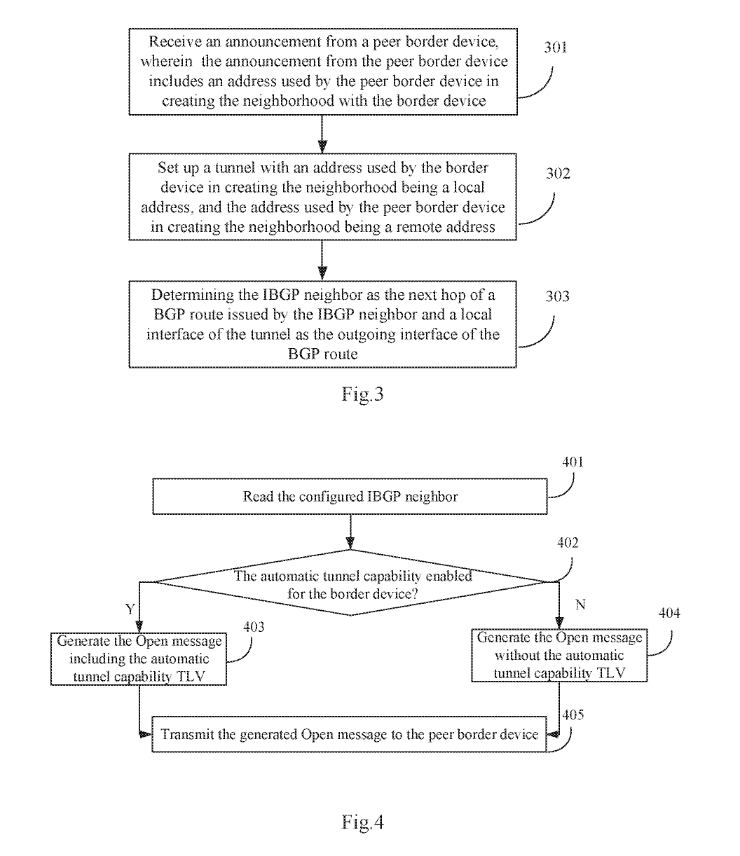

In an example, the processor 211 of the border device reads the machine readable instructions corresponding to the routing control logic, stored in the memory 212 to perform an operational flow as illustrated in FIG. 3.

At block 301, the border device receives an announcement from an IBGP neighbor (also referred to as IBGP peer border device, and simply referred to as peer border device in this example), wherein the announcement from the peer border device includes an address used by the peer border device in creating the neighborhood. The peer border device notifies the address used by the peer border device in creating the neighborhood with the border device, in the transmitted announcement.

At block 302, the border device sets up a tunnel with an address used by the border device in creating the neighborhood with the peer border device being a local address, and the address used by the peer border device in creating the neighborhood with the border device being a remote address. A local address refers to an address of the border device setting up the tunnel in block 302 and a remote address refers to an address of the peer border device on the other end of the tunnel. For instance, with reference to FIG. 1, the tunnel may be set up between the routing device 121 and the routing device 122. If routing device 121 is the border device that sets up the tunnel at block 302, then the local address is an address of routing device 121 and the remote address is an address of routing device 122 which is the peer border device.

In this example, the tunnel maybe set up in any tunnel protocol, for example, a Generic Routing Encapsulation (GRE) tunnel, an Internet Protocol Security (IPSEC) tunnel, etc., maybe set up. In this example, either a un-directional tunnel or a bidirectional tunnel maybe set up.

At block 303, the border device determines the IBGP neighbor (i.e. the peer border device) as the next hop of a BGP route issued by the IBGP neighbor and a local interface of the tunnel as the outgoing interface of the BGP route.

In an example, the process of block 303 may be referred to as the process of the route relay. In one example, according to the route relay, a route with the local interface of the tunnel being the outgoing interface is issued to a forwarding platform of the border device. Then a data message that is to enter an AS through the border device and leaving the AS through the peer border device on the other side of the tunnel is encapsulated by the border device. The encapsulated data message may include a source address which is the address of the border device in creating the neighborhood with the peer border device, and a destination address which is the address of the peer border device in creating the neighborhood with the border device, both of which are addresses within the AS. In this way a routing device within the AS may calculate a forwarding path for the encapsulated data message from the border device to the peer border device according to the IGP. In other words, the forward path of the setup tunnel within the AS is determined by the IGP operating on the AS. The peer border device de-encapsulates the encapsulated data message and forwards the data message over the BGP route upon reception of the data message.

For instance, in the AS 120 of FIG. 1, if routing devices 121 receives a BGP route issued by routing devices 122, then the process of the route relay is as follow: routing devices 121 determines routing devices 122 as the next hop of the BGP route and a local interface of the tunnel as the outgoing interface of the BGP route. According to the route relay, if routing devices 121 receives a data message form routing devices 111 to routing devices 131, routing devices 121 encapsulates the data message wherein a source address is an address of routing devices 121 and a destination address is an address of routing devices 122.

After the data message traversing the AS is encapsulated using the addresses within the AS, the data message traverses the AS according to the IGP. The source address and the destination address of the encapsulated data message are determined by the BGP route outside the AS independent of the data message being forwarded within the AS. Thus no route black-hole will be formed even if the IGP does not match in convergence rate the BGP. A routing device on which the BGP does not operate within the AS will neither need to know the BGP route nor need to operate another protocol (e.g., the LDP) in order to avoid a route black-hole, so there will be neither increase in burden on the routing device nor degraded performance of the IGP. The tunnel maybe set up automatically, and the route maybe relayed automatically, without increasing the workload of the network administrator.

If the bidirectional tunnel is set up in the block 302, then the peer border device may relay the BGP route issued by the border device over the tunnel. If the unidirectional tunnel is set up, then the peer border device may initiate setting up of the unidirectional tunnel to the border device, using the address of the border device known in setting up the tunnel. In other words, the tunnel may be set up between the two border devices as long as one border device of the two border devices transmits an announcement to the other border device of the two border devices to notify the other border device of the address used by the one border device in creating the neighborhood with the other border device.

The border device on one side or the other side may create the neighborhood using an address of a physical interface or an address of a virtual interface. If the neighborhood is created using the address of the physical interface, the neighborhood may be broken when the physical interface fails. If the neighborhood is created using the address of the virtual interface, then higher availability may be achieved using a redundant link within the AS, for example, the neighborhood may be created using an address of a loopback interface.

In this example, the border device may transmit an announcement on its own initiative to the peer border device, wherein the announcement carries an address used by the border device in creating in the neighborhood with the peer border device.

In some network deployment structure, some border device may not support the routing control logic in this example. In this case, the border device may negotiate with the peer border device about its capability to set up a tunnel automatically and to relay a BGP route over the tunnel, before transmitting an announcement thereto. If the peer border device has no such a capability, then the border device may not apply the routing control logic in this example to process the BGP route issued by the peer border device. A capability negotiation procedure maybe performed by extending the BGP protocol in use or applying a message in a self-defined format.

In this example, the state of the setup tunnel maybe maintained so that the BGP route will be modified in a timely manner when the tunnel fails. In a example, the setup tunnel is checked periodically for connectivity, for example, a heartbeat message is transmitted to the peer border device, and the state of the tunnel is known by determining whether an acknowledge message retuned by the peer border device; and if the connectivity check fails, then the BGP route will not be relayed with the local interface of the tunnel being the outgoing interface, but delete the forward path corresponding to the tunnel, on the forward platform of the border device.

In another example, an AS includes several border devices on which the BGP operates, and these border devices create IBGP neighborhoods with each other via a loopback interface, and creates EBGP neighborhoods with border devices of another AS. The AS includes several IGP routing devices on which the BGP does not operate, and the IGP operates on these IGP routing devices, and the border devices in the present AS to forward a message within the AS. The routing control logic in this example operates on at least one of the border devices.

The border device maintains a tunnel information table on a machine readable storage medium in a structure as depicted in Table 1. After the BGP neighborhood is configured on the border device, the border device adds an entry automatically according to obtained the peer border device information and other information of the added entry is temporally absent.

TABLE 1

| | | | | |
|---|---|---|---|---|
| IBGP | IP address | IP address | Tunnel | Tunnel |
| neighborhood | locally used | used by the | name | state |
| information | in creating | peer border | | |
| | the | device in | | |
| | neighborhood | creating the | | |
| | | neighborhood | | |

After the BGP neighborhood is configured on the border device, the border device may negotiate with the peer border device about parameters by exchanging a BGP Open message therewith. In this example, an optional automatic tunnel capability Type-Length-Value (TLV) construct is added to the BGP Open message so that the border devices negotiate with each other about the automatic tunnel capability (i.e., the support of the routing control logic in this example). The TLV construct may include the following fields: a Capability Code field which is a predefined value on the border device; and a Capability Length field with the value of 0 indicating that the length of a Capability Value field in the present TLV is 0. When the two border devices create the IBGP neighborhood, if one of the border devices has the automatic tunnel capability, then it may transmit the Open message carrying the automatic tunnel capability TLV; otherwise, it may transmit the Open message without the automatic tunnel capability TLV.

The Open message maybe transmitted on the border device in a flow as illustrated in FIG. 4:

At block 401, the border device starts a flow of creating the IBGP neighbor and to read the configured IBGP neighbor;

At block 402, the border device determines whether the automatic tunnel capability is enabled for the border device; and if so, then the flow proceed to the block 403; otherwise, the flow proceeds to the block 404;

At block 403, the border device generates the Open message including the automatic tunnel capability TLV, and the flow jumps to the block 405;

At block 404, the border device generates the Open message including no automatic tunnel capability TLV; and

At block 405, the border device transmits the generated Open message to the peer border device.

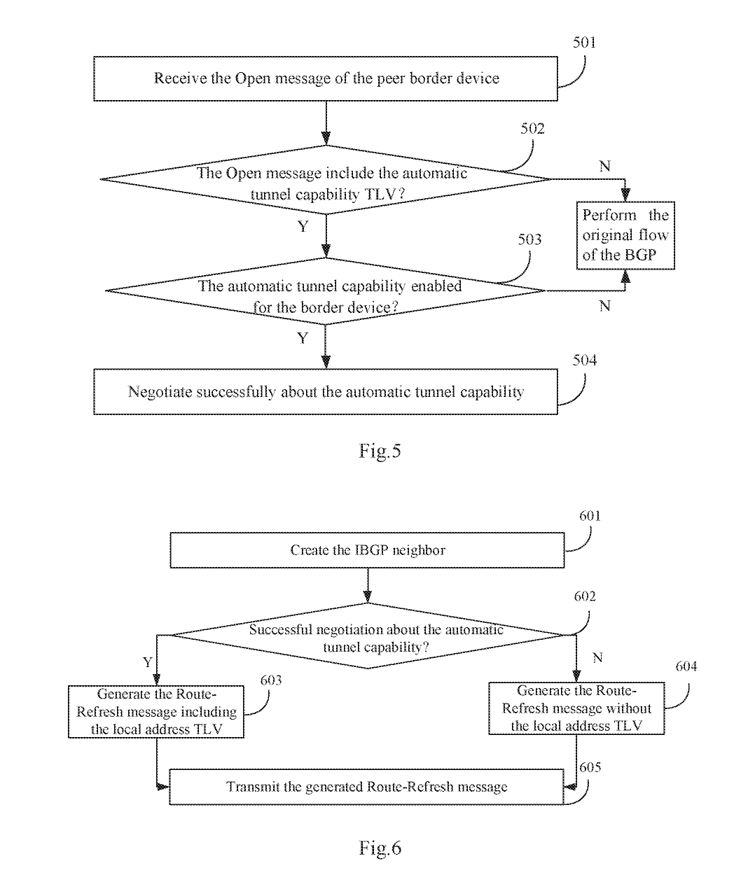

The Open message received from the peer border device may be processed on the border device in a flow as illustrated in FIG. 5:

At block 501, the border device receives the Open message of the peer border device;

At block 502, the border device determines whether the Open message includes the automatic tunnel capability TLV; and if so, then the flow proceeds to the block 503; otherwise, to perform the original operational flow in the BGP protocol;

At block 503, the border device determines whether the automatic tunnel capability is enabled for the border device; and if so, then the flow proceeds to the block 504; otherwise, to perform the original operational flow in the BGP protocol; and

At block 504, the border device negotiates with the peer border device successfully about the automatic tunnel capability.

After negotiating with the peer border device successfully about the automatic tunnel capability, the border device transmits an announcement to the peer border device, so as to notify the peer border device of the IP address used by the border device in creating the neighborhood with the peer border device; and receives an announcement from the peer border device and obtains the IP address used by the peer border device in creating the neighborhood with the border device from the announcement received from the peer border device. The border device stores the IP addresses used by the border device and the peer border device in creating the neighborhood with each other into the entry of the peer border device in the tunnel information table.

In this example, a BGP Route-Refresh message maybe transmitted as the announcement to the peer border device by adding thereto a new local address TLV construct to distribute the IP address used by the border device in creating the neighborhood with the peer border device. The added local address TLV may include a Route-Address field carrying previously transmitted route information, a Length field indicating an IP address attribute length, and an IP Address field carrying the IP address used by the border device in creating the neighborhood with the peer border device.

The Route-Refresh message maybe transmitted on the border device to the peer border device in a flow as illustrated in FIG. 6:

At block 601, the border device creates the IBGP neighbor;

At block 602, the border device determines whether the border device negotiates with the peer border device successfully about the automatic tunnel capability thereof; and if so, then the flow proceeds to the block 603; otherwise, the flow proceeds to the block 604;

At block 603, the border device generates the Route-Refresh message including the local address TLV and to jump to the block 605;

At block 604, the border device generates the Route-Refresh message without the local address TLV; and

At block 605, the border device transmits the generated Route-Refresh message.

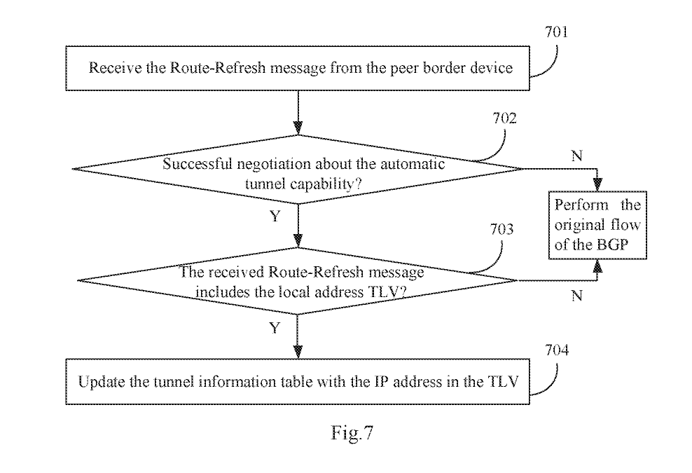

The Route-Refresh message received from the peer border device may be processed on the border device in a flow as illustrated in FIG. 7.

At block 701, the border device receives the Route-Refresh message from the peer border device;

At block 702, the border device determines whether the border device negotiates with the peer border device successfully about the automatic tunnel capability; and if so, then the flow proceeds to the block 703; otherwise, to perform the original operational flow of the BGP protocol;

At block 703, the border device determines whether the received Route-Refresh message includes the local address TLV; and if so, then the flow proceeds to the block 704; otherwise, to perform the original operational flow of the BGP protocol; and

At block 704, the border device extracts the IP address carried in the local address TLV of the Route-Refresh message and to store the IP address as the IP address used by the peer border device in creating the neighborhood into the tunnel information table of the peer border device.

After the IP address used by the peer border device in creating the neighborhood is obtained, the border device sets up the virtual GRE tunnel with the IP address locally used in creating the neighborhood, in the entry of the peer border device in the tunnel information table, being the source address, and the IP address used by the peer border device in creating the neighborhood, in the entry of the peer border device in the tunnel information table, being the destination address, and writes the tunnel name and the tunnel state into the entry in the tunnel information table after setting up the tunnel. The setup virtual GRE tunnel will not be configured with an additional tunnel interface but can be issued to the forward plane of the border device for forwarding of the data message.

In order to guarantee bidirectional connectivity over the GRE tunnel, the GRE keep-alive function maybe enabled for the setup virtual GRE tunnel, so that bidirectional connectivity over the GRE tunnel maybe checked by transmitting a message periodically over the tunnel, and the tunnel state in the tunnel information table maybe maintained according to a result of the connectivity check. If the GRE tunnel passes the connectivity check, then the tunnel state is set to UP (enabled); otherwise, the tunnel state is set to Down (disabled).

For the GRE tunnel in the state of UP, the border device relays the BGP route with the local interface of the GRE tunnel being the outgoing interface. For the GRE tunnel in the state of Down, a timer is started, the periodical connectivity check is further performed, and if the connectivity check is passed before the timer expires, then the state of the GRE tunnel is modified; or if the connectivity check is still not passed when the timer expires, then it is determined that the connectivity check fails, and the border device may not relay the BGP route any longer but tear down the forward path corresponding to the GRE tunnel, on the forward platform. The GRE tunnel may fail temporally before another forward path is generated according to the IGP, because the current forward path thereof within the AS fails, so the counting length of time of the timer, e.g., 30 seconds, maybe determined as a function of the forward rate within the AS, and the convergence rate of the IGP.

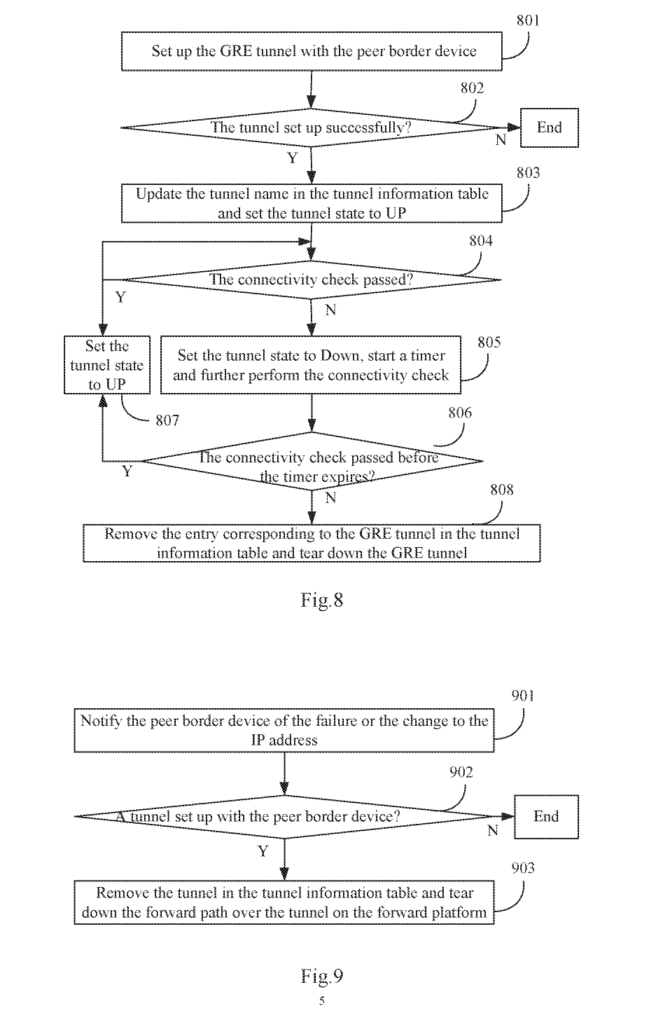

The tunnel maybe set up and the connectivity check maybe performed by the border device in a flow as illustrated in FIG. 8:

At block 801, the border device sets up the GRE tunnel with a peer border device with the IP address used by the border device in creating the neighborhood with the peer border device, in the entry of the peer border device in the tunnel information table, being the source address, and the IP address used by the peer border device in creating the neighborhood with the border device, in the entry of the peer border device in the tunnel information table, being the destination address;

At block 802, the border device determines whether the tunnel is set up successfully; and if so, then the flow proceeds to the block 803; otherwise, the flow ends;

At block 803, the border device updates the tunnel name in the entry corresponding to the peer border device in the tunnel information table and set the tunnel state to UP;

At block 804, the border determines whether the connectivity check of the GRE tunnel is passed, and if so, to wait for the connectivity check in the next cycle, that is, the flow proceeds again to the block 804; otherwise, the flow proceeds to the block 805;

At block 805, the border device sets the state of the GRE tunnel in the tunnel information table to Down; and to start the timer, and to perform the connectivity check;

At block 806, the border device determines whether the connectivity check is passed before the timer expires; and if so, then the flow proceeds to the block 807; otherwise, the flow proceeds to the block 808;

At block 807, the border device sets the state of the tunnel to UP and to jump to the block 804; and

At block 808, the border device removes the entry corresponding to the GRE tunnel in the tunnel information table and to tear down the GRE tunnel.

When the peer border device fails or the IP address used by the peer border device in creating the neighborhood with the border device is changed, the border device removes the entry of the peer border device in the tunnel information table, and tears down the forward path on the forward platform, corresponding to the GRE tunnel set up with the peer border device.

The GRE tunnel maybe tore down by the border device in a flow as illustrated in FIG. 9:

At block 901, the border device knows that the peer border device fails or the IP address used by the peer border device in creating the neighborhood with the border device is changed;

At block 902, the border device determines whether there is a GRE tunnel set up with the peer border device, and if so, then the flow proceeds to the block 903; otherwise, the flow ends; and

At block 903, the border device removes the entry corresponding to the GRE tunnel in the tunnel information table, and to tear down the forward path corresponding to the GRE tunnel on the forward platform.

After the GRE tunnel is set up with the peer border device, the border device determines from which peer border device the BGP route which can be validated relayed originates, upon reception of the route from the peer border device; and then searches the tunnel information able of the border device for a GRE tunnel with the peer border device, in the state of UP, and if the next hop of the BGP route is the peer border device on the other side of the GRE tunnel, then the border device relays the outgoing interface of the BGP route onto the GRE tunnel, and distributes the route to the forward plane to direct forwarding of the data message. The border device performs the original relay flow of the BGP protocol on the route from the EBGP neighbor.

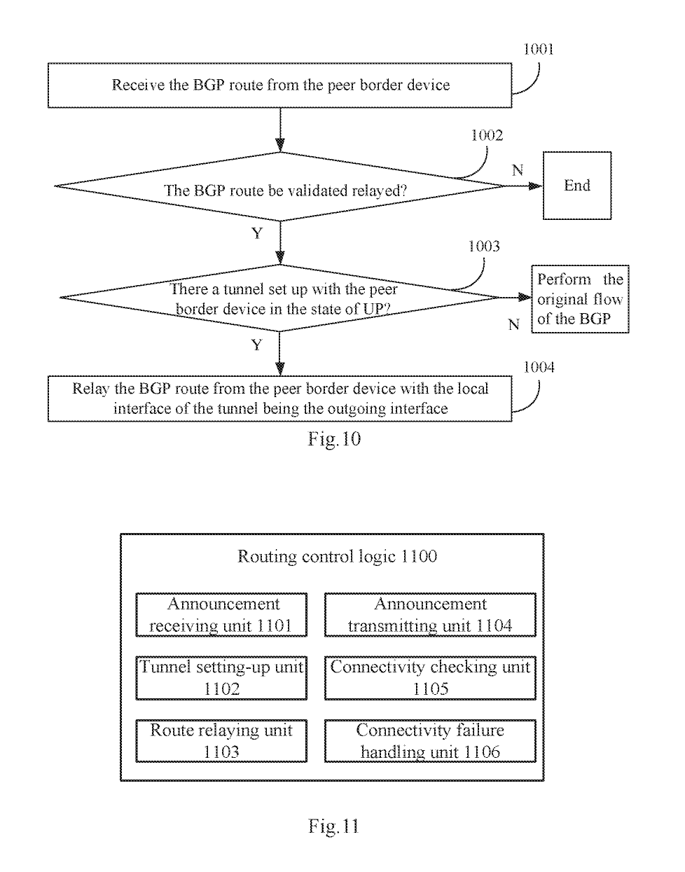

The route from the peer border device may be relayed in a flow as illustrated in FIG. 10:

At block 1001, the border device receives the BGP route from the peer border device;

At block 1002, the border device determines whether the BGP route may be validated relayed; and if so, then the flow proceeds to the block 1003; otherwise, the flow ends;

At block 1003, the border device determines whether there is a GRE tunnel set up with the peer border device, in the state of UP; and if so, then the flow proceeds to the block 1004; otherwise, to further perform the original operational flow of the BGP protocol; and

At block 1004, the border device relays the BGP route from the peer border device with the local interface of the GRE tunnel being as the outgoing interface.

The application provides a routing control logic device for traversing an autonomous system as illustrated in FIG. 11 which functionally includes an announcement receiving unit 1101, a tunnel setting-up unit 1102, a route relaying unit 1103, an announcement transmitting unit 1104, a connectivity check unit 1105, and a connectivity failure handling unit 1106.

The announcement receiving unit 1101 is configured to receive an announcement from an Interior Border Gateway Protocol (IBGP) neighbor, wherein the announcement from the IBGP neighbor includes an address used by the IBGP neighbor in creating the neighborhood with the border device;

The tunnel setting-up unit 1102 is configured to set up a tunnel with an address used by the border device in creating the neighborhood with the IBGP neighbor being a local address, and the address used by the IBGP neighbor in creating the neighborhood with the border device being a remote address;

The route relaying unit 1103 is configured to determine the IBGP neighbor as the next hop of a BGP route issued by the IBGP neighbor and a local interface of the tunnel as the outgoing interface of the BGP route; and

The announcement transmitting unit 1104 is configured to transmit an announcement carrying the address used by the border device in creating the neighborhood to the IBGP neighbor.

In an example, the announcement is a BGP Route-Refresh message.

The connectivity check unit 1105 is configured to perform connectivity check periodically on the tunnel; and

The connectivity failure handling unit 1106 is configured to stop the IBGP neighbor being the next hop of the BGP route and the local interface of the tunnel being the outgoing interface of the BGP route, and to tear down the tunnel, when the connectivity check fails.

In an example, the address used in creating the neighborhood includes an address of a loopback interface.

1. A routing method for traversing an Autonomous System (AS), applicable to a border device on which a Border Gateway Protocol (BGP) is operating, the method comprising:
receiving an announcement from an Interior Border Gateway Protocol (IBGP) neighbor, wherein the announcement from the IBGP neighbor comprises an address used by the IBGP neighbor in creating the neighborhood with the border device;
setting up a tunnel with an address used by the border device in creating the neighborhood with the IBGP neighbor being a local address and the address used by the IBGP neighbor in creating the neighborhood with the border device being a remote address; and
determining the IBGP neighbor as the next hop of a BGP route issued by the IBGP neighbor and a local interface of the tunnel as the outgoing interface of the BGP route.

2. The method according to claim 1, further comprises:
transmitting an announcement carrying the address used by the border device in creating the neighborhood to the IBGP neighbor.

3. The method according to claim 1, wherein the announcement is a BGP Route-Refresh message.

4. The method according to claim 1, further comprises:
performing connectivity check periodically on the tunnel; and
stopping the IBGP neighbor being the next hop of the BGP route and the local interface of the tunnel being the outgoing interface of the BGP route, and tearing down the tunnel, if the connectivity check fails.

5. The method according to claim 1, wherein the address used in creating the neighborhood includes an address of a loopback interface.

6. The method according to claim 1, wherein a forward path of the tunnel within the AS is determined by an Interior Gateway Protocol (IGP) operating on the AS.

7. A border device, comprising a processor and a storage medium, wherein the processor reads machine readable instructions stored in the storage medium to perform the operations of:
receiving an announcement from an Interior Border Gateway Protocol (IBGP) neighbor, wherein the announcement from the IBGP neighbor comprises an address used by the IBGP neighbor in creating the neighborhood with the border device;
setting up a tunnel with an address used by the border device in creating the neighborhood with the IBGP neighbor being a local address, and the address used by the IBGP neighbor in creating the neighborhood with the border device being a remote address; and
determining the IBGP neighbor as the next hop of a BGP route issued by the IBGP neighbor and a local interface of the tunnel as the outgoing interface of the BGP route.

8. The border device according to claim 7, wherein the processor reads the machine readable instructions stored in the storage medium to further perform the operations of:
transmitting an announcement carrying the address used by the border device in creating the neighborhood to the IBGP neighbor.

9. The border device according to claim 8, wherein the announcement is a BGP Route-Refresh message.

10. The border device according to claim 7, wherein the processor reads the machine readable instructions stored in the storage medium to further perform the operations of:
performing connectivity check periodically on the tunnel; and
stopping the IBGP neighbor being the next hop of the BGP route and the local interface of the tunnel being the outgoing interface of the BGP route, and tearing down the tunnel, if the connectivity check fails.

11. The border device according to claim 7, wherein the address used in creating the neighborhood includes an address of a loopback interface.
